(19) United States
(12) Patent Application Publication
(10) Pub. No.: US 2007/0151128 A1
(43) Pub. Date: Jul. 5, 2007

(54) Cutting attachment for landscaping equipment and a method of cutting a swale therewith

(76) Inventors: Kenneth E. Hebert, Canton, OH (US); Troy Hebert, Canton, OH (US)

Correspondence Address: SAND & SEBOLT, AEGIS TOWER, SUITE 1100, 4940 MUNSON STREET, NW, CANTON, OH, 44718-3615, US

(21) Appl. No.: 11/649,044

(22) Filed: Jan. 3, 2007

Related U.S. Application Data
(60) Provisional application No. 60/756,052, filed on Jan. 4, 2006.

(51) Int. Cl. A01B 13/00

(52) U.S. Cl. 37/301

(57) ABSTRACT

A cutting attachment for forming a swale in a substantially level area of terrain. The cutting attachment is designed to be connected to a landscaping vehicle, such as a skid-steer. The attachment comprises a frame which has a first immobile blade mounted to a front end thereof. First blade is substantially V-shaped when viewed from above and comprises three integrally formed and immovably connected sections. The three sections are disposed at particular angles to each other. Each of the sections includes a straight portion and a rearwardly angled portion that extends outwardly away therefrom. As the landscaping vehicle is moved in a first direction across the terrain, the first blade cuts into the terrain and creates a shallow depression therein. The shallow depression mirrors the profile of the shape of the first blade of the cutting attachment. The attachment further includes a second blade that is pivotally connected to an outer surface of the first blade. The second blade is substantially flat and is adapted to push soil in front of it when the vehicle is moved in a second direction across the terrain.

### BACKGROUND OF THE INVENTION

### TECHNICAL FIELD

This invention generally relates to landscaping equipment. More particularly, the invention relates to cutting attachments for landscaping applications. Specifically, the invention relates to a cutting attachment for a skid-steer that includes a first blade having three segments in fixed orientation relative to each other to form a truncated V-shape that cuts swales into the terrain as the skid-steer is moved thereover.

### BACKGROUND INFORMATION

Builders fairly frequently have to shape and mold the terrain around the buildings they are constructing. This is particularly true when two houses, for example, are erected side by side on fairly flat terrain. If the terrain is not shaped in an appropriate manner, i.e., by creating a slope to cause surface water to drain away from the buildings, then surface water may pool against the foundations and ultimately cause extensive damage thereto. It is therefore common to either grade soil against the structure to create a slope away from the building or, alternatively, to cut a swale into the terrain. A swale is a very slightly sloped depression that runs along the contour of the land. They are gently angled in cross-section and have a longitudinal slope of about 24 inches per 100 feet. Swales are designed to appear to be a natural part of the landscape and to be easily negotiated by lawn mowers and other landscaping equipment. These depressions gently direct surface water away from the buildings and will tend to hold a quantity of surface water so that it can slowly drain into the soil some distance away from the foundations of the buildings.

It can be fairly time consuming and difficult to construct swales because of the need to form such a gentle slope. It tends to take a skilled operator a few hours and many passes with landscaping equipment before a proper slope is attained. Builders and landscapers prefer to use dozers with straight blades to shape the soil as best as possible because dozers can move fairly large quantities of soil with ease and have fewer problems with obstacles such as roots and rocks. In confined spaces, however, a dozer may be too large for the space provided and in these instances the equipment of choice tends to be skid-steers. A skid-steer can move more easily in confined spaces because of its smaller size and weight, but because of their reduced weight and lower horsepower, they cannot move large quantities of soil quickly and they struggle to cut a smooth slope in the terrain. Skid-steers will tend to leave small mounds of soil when the blade encounters obstacles such as tree roots or rocks. These soil mounds will substantially impede the flow of surface water through the swale and therefore have to be eliminated.

There is therefore a need in the art for a piece of landscaping equipment that will aid the builder or landscaper to cut swales quickly and easily in confined spaces.

### SUMMARY OF THE INVENTION

The device of the present invention comprises a cutting attachment for a landscaping vehicle such as a skid-steer. The attachment comprises a frame which has a first blade mounted to a front end thereof. This first blade is a substantially open and truncated V-shaped when viewed from above. The first blade comprises three segments that are disposed at particular angles to each other. The three segments do not move relative to each other but always maintain their fixed shape and orientation relative to each other. Each of the three segments of the first blade includes a straight portion and an angled portion. The angled portion extends outwardly away from the straight portion and toward the end of the frame attached to the vehicle. The first blade cuts a swale into the terrain as the landscaping vehicle is moved in a first direction across the terrain. The attachment further includes a second blade that is pivotally connected to an outer surface of the first blade. The second blade is substantially flat and is adapted to push soil in front of it when the vehicle is moved in a second direction across the terrain.

### BRIEF DESCRIPTION OF THE DRAWINGS

The preferred embodiment of the invention, illustrative of the best mode in which applicant has contemplated applying the principles, is set forth in the following description and is shown in the drawings and is particularly and distinctly pointed out and set forth in the appended claims.

FIG. 1 is a side elevational view of a skid steer with the cutting attachment of the present invention mounted thereon;

FIG. 2 is a front elevational view of the skid steer with the cutting attachment thereon;

FIG. 3 is a front perspective view of the cutting attachment in accordance with the present invention;

FIG. 4 is a rear perspective view of the cutting attachment of the present invention;

FIG. 5 is a partial cross-sectional side view through line 5-5 of FIG. 2 and showing the cutting attachment in an initial position on the flat terrain to be shaped;

FIG. 6 is a front view of the skid-steer with the cutting attachment in an initial position;

FIG. 7 is a partial cross-sectional side view of the cutting attachment through line 7-7 of FIG. 6 and showing the swale cutting blade removing a quantity of soil from the flat terrain; and

FIG. 8 is a front view showing the cross-sectional shape of the swale cut into the terrain by the cutting attachment of the present invention

### DETAILED DESCRIPTION OF THE INVENTION

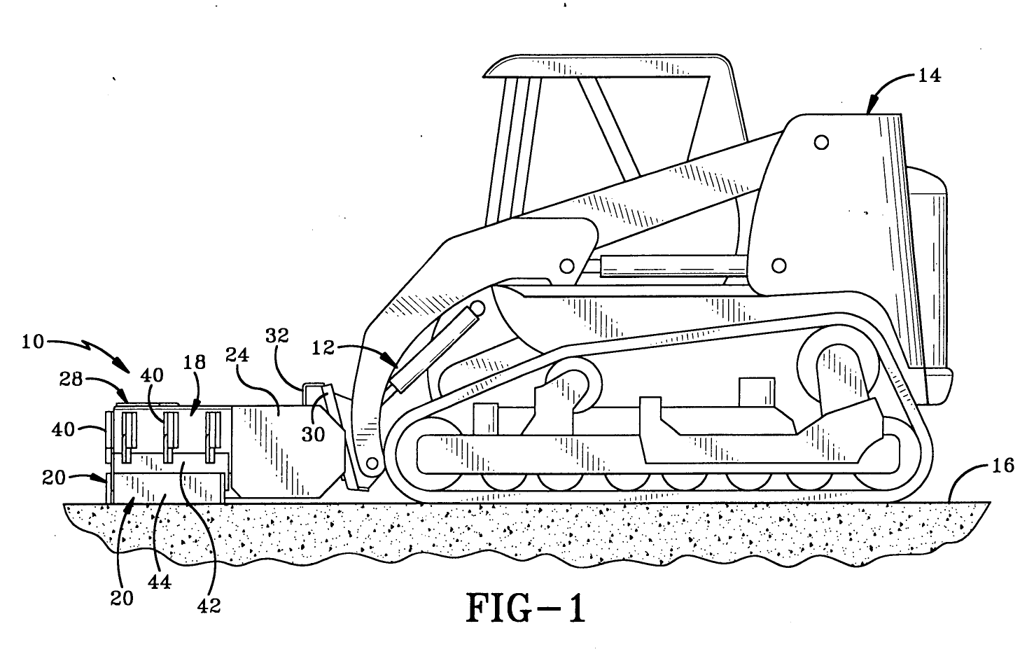

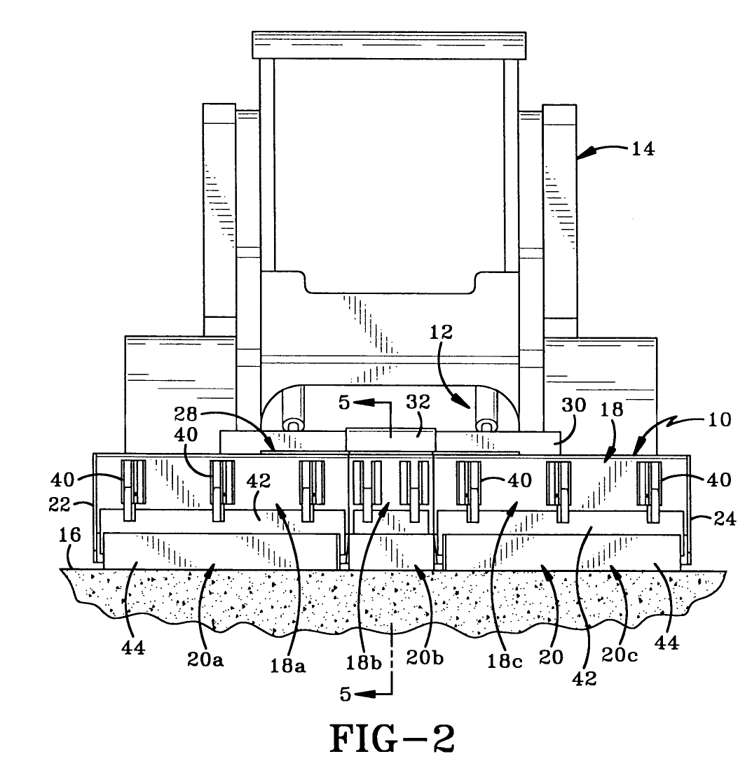

Referring to FIGS. 1 and 2, there is shown a cutting attachment 10 in accordance with the present invention. The cutting attachment 10 is operationally connected to an actuating system 12 of a landscaping vehicle 14. The actuating system 12 may be hydraulic, pneumatic or a combination of both. The landscaping vehicle of choice in this instance is a skid-steer, but it will be understood that dozers, tractors and the like could also be used to operate this cutting attachment 10. Skid steer 14 is used to cause cutting attachment 10 to form a swale in the terrain 16.

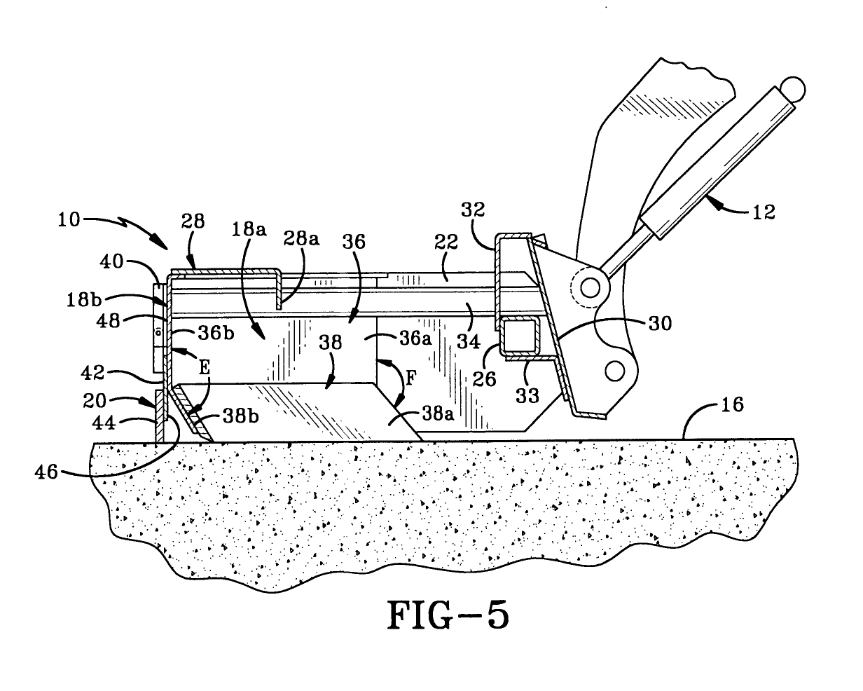

Referring to FIGS. 3-7, cutting attachment 10 comprises a frame which includes a first fixed blade 18 and a second pivotable blade 20 which form a front end “A” (FIG. 3) of cutting attachment 10. The frame further includes a pair of side walls 22, 24 that extend rearwardly from first blade 18 and a crossbar 26 that extends between side walls 22, 24. A first shield 28 is secured, preferably by welding, to the upper end of first blade 18 proximate front end “A” of cutting attachment 10. Crossbar 26 forms a rear end “B” of cutting attachment 10 and a connector plate 30 is secured to a rearward side of crossbar 26. Connector plate 30 provides a mechanism for removably latching attachment 10 to vehicle 14 and is adapted to be connected to the hydraulic system 12 of skid steer 14. Two substantially L-shaped pieces 32 and 33 (FIG. 5) extend forwardly from connector plate 30 and crossbar 26 is retained between these pieces 32, 33 and front surface 30a of connector plate 30. Crossbar 26 preferably is welded to front surface 30a of connector plate 30 and to pieces 32 &33. Connector plate 30 is also secured to first blade 18 by a pair of cross-braces 34. Shield 28 is positioned between these cross-braces 34 proximate front end “A” of the frame and includes a downwardly extending rear end 28a (FIG. 5). Connector plate 30 is secured to the hydraulic system 12 of skid-steer 14 in any suitable manner known in the art for connecting attachments to these types of vehicles. It will be understood by those skilled in the art that while the connector plate 30 is the preferred mechanism for securing attachment 10 to vehicle 14, attachment 10 may be latched to vehicle 14 in other ways, such as by interlockingly receiving of portions of the vehicle 14 through the gaps that are created by the side walls 22, 24, crossbar 26 and other members of the frame of attachment 10

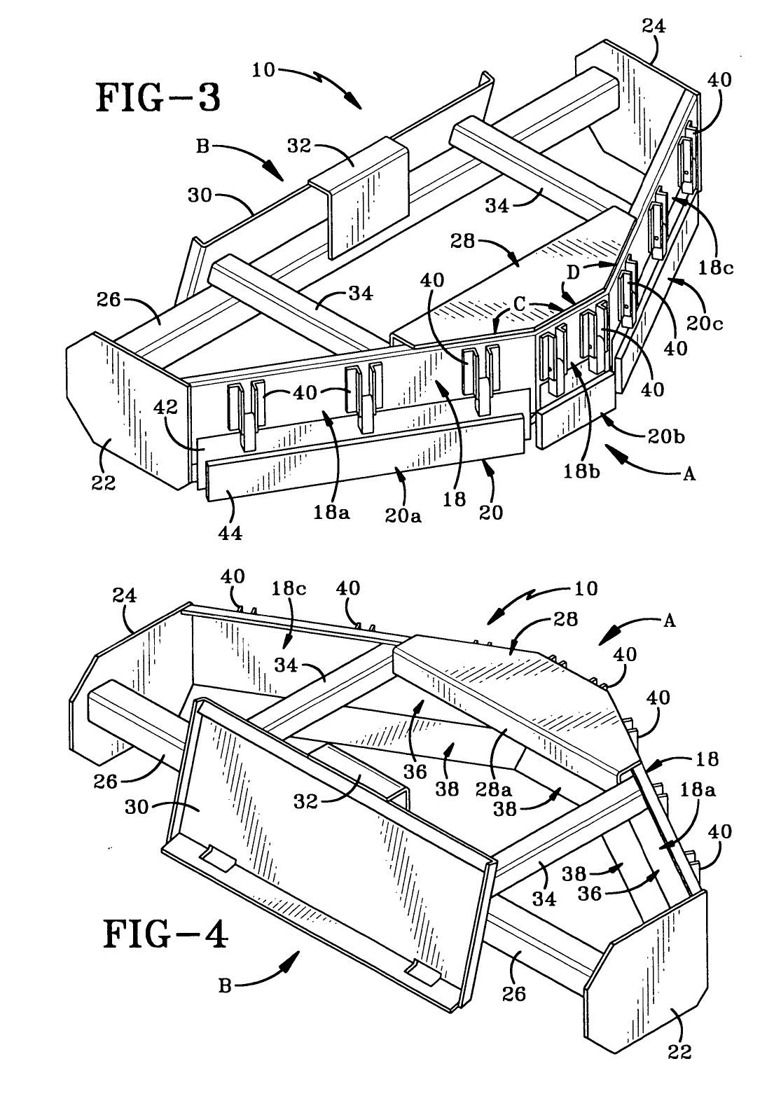

First blade 18 comprises a single, rigid member that is made up from three segments, namely segments 18a, 18b and 18c (FIGS. 3&4) that are immovably connected together. The segments 18a, 18b and 18c may be integrally formed from a shaped, single piece of metal or may be three separate pieces of metal welded together. First blade 18 is a substantially open-V-shaped member when viewed from above. As shown in FIG. 4, the apex of the V-shape of first blade 18 is truncated in that segment 18b does not terminate in a point, but is instead aligned substantially parallel to crossbar 26. Furthermore, segment 18b is positioned farther outwardly away from the front end of vehicle 14 than are segments 18a and 18c. First blade 18 has an outer surface that is remote from the landscaping vehicle and an inner surface that is closer to the landscaping vehicle.

In accordance with one of the specific features of the present invention, segments 18a, 18b and 18c of first blade 18 are disposed at fixed angles relative to one another. These relative angles cause cutting attachment 10 to cut a swale in the terrain as it is drawn across the same. Angle “C” (FIG. 3), between segments 18a and 18b, is between 140° and 160° and preferably is 150°. Angle “D”, between segments 18b and 18c, is between 140° and 160° and preferably is 150°. Furthermore, when viewed from the side, each of segments 18a, 18b and 18c comprises a generally vertical straight portion 36 and an angled portion 38 that extends rearwardly from the straight portion 36. These straight and angled portions 36, 38 are most easily seen in FIGS. 4 & 5. The angle “E” between straight portion 36b and angled portion 38b preferably is 145°. The angle “F” which exists between straight portion 36a and angled portion 38b and also between straight portion 36c and angled portion 38c preferably is 150°. Straight and angled portions 36, 38 preferably are integrally formed but may, of course, be welded or otherwise secured to each other.

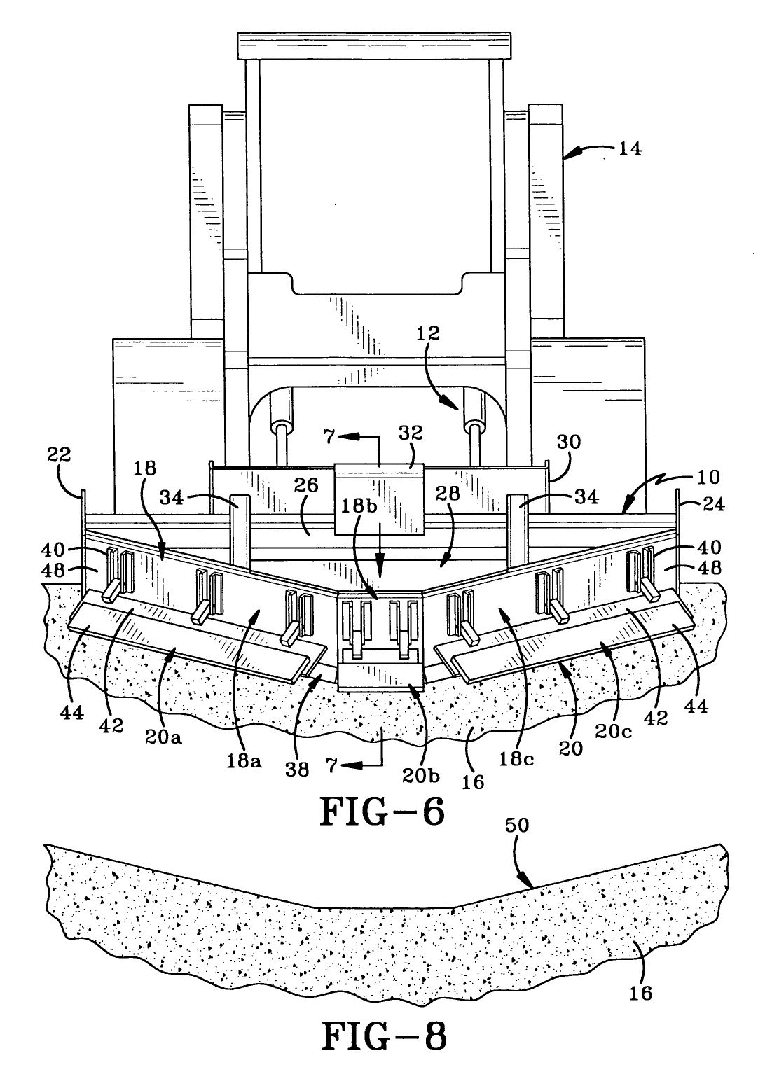

Second blade 20 comprises three sections, namely, 20a, 20b and 20c, each of which is individually pivotally secured to the outer surface of a respective segment 18a, 18b or 18c of first blade 18 by a plurality of connectors 40. As seen from FIG. 6, each of the second blade sections 20 comprises a first plate 42 and a second plate 44. First plate 42 is pivotally secured via connectors 40 to first blade 18. Connectors 40 are gravity-actuated so that if first blade 18 is tilted, connectors 40 allow second blade 20 to swing freely in response to said tilting motion either toward or away from the outer surface of first blade 18. Second plate 44 is detachably secured to first plate 42 and first and second plates 42, 44 act as a unit. Second plate acts 44 is a wear plate that may be flipped over or replaced as it is worn down.

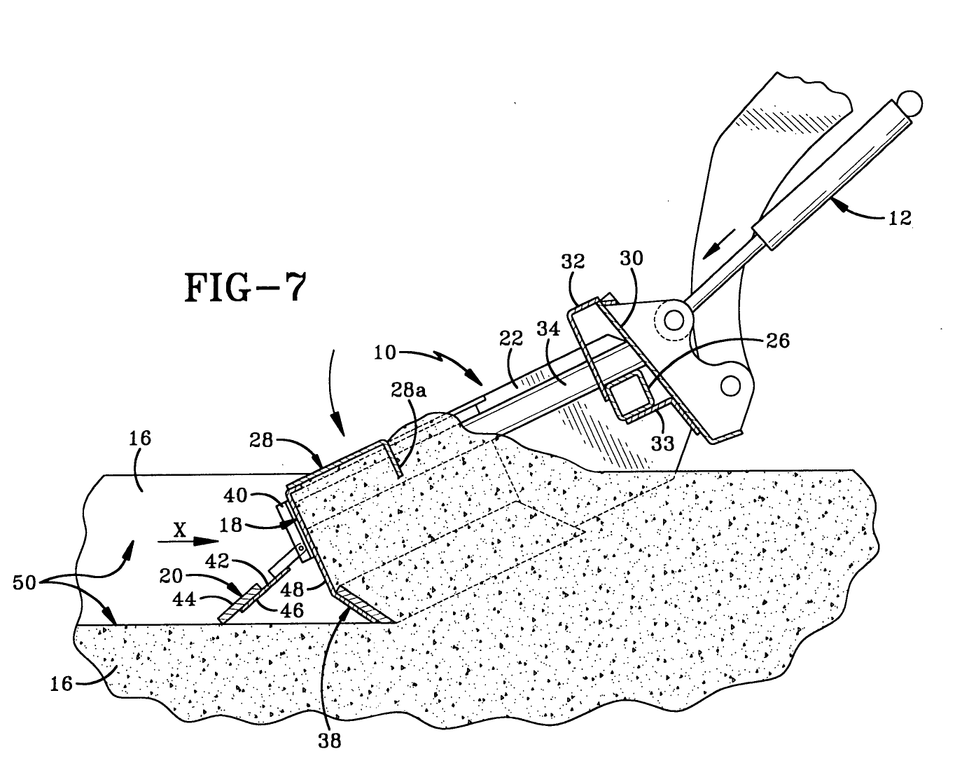

Referring to FIGS. 5-8, cutting attachment 10 is used in the following manner. FIG. 5 illustrates cutting attachment 10 at rest on the terrain prior to beginning the cutting operation. At this rest stage, both of the first and second blades 18, 20 rest on the terrain 16 with the interior surface 46 of second blade 20 laying in abutting contact with the exterior surface 48 of first blade 18. The skid steer operator engages the hydraulic actuators 12, tilting cutting attachment 10 so that first blade 18 bites into the terrain 16. The tilting motion causes second blade 20 to pivot so that second blade 20 swings outwardly away from first blade 18 and second blade's interior surface 46 no longer contacts exterior surface 48 of first blade 18. The skid-steer 14 is also simultaneously reversed as indicated by the arrow “X” (FIG. 7). As skid-steer 14 is reversed across terrain 16, angled portions 38 of first blade 18 gather a quantity of soil which slides up angled portions 18 and accumulates behind straight portions 36 of first blade 18 and shield 28. The accumulated material. is gathered by cutting attachment 10 and is dragged backwardly by skid-steer 14, leaving behind a gently sloped depression 50 in the terrain 16. Second plate 44 of second blade 20 is also drawn across surface aiding in smoothing out small inconsistencies in the terrain. The profile of that depression or swale 50 is shown in FIG. 8. The profile of swale 50 is substantially the same shape as the shape of first blade 18. After the initial sweep, the operator will actuate the hydraulics 12 on skid-steer 14 to move skid-steer 14 forwardly in the opposite direction to arrow “X” across the terrain. The hydraulics 12 move the cutting attachment 10 back into the position shown in FIG. 1. Connectors 40 allow second blades 20 to pivot back into abutting contact with first blade 18. Skid-steer 14 is then driven forwardly over the terrain. First and second plates 42, 44 present a substantially vertical front blade for pushing soil in front of cutting attachment, thereby aiding in smoothing out the terrain while maintaining the profile cut by first blade 18. The operator of skid-steer 14 may need to travel over the same piece of terrain a few times in order to remove the necessary quantity of soil. A pile of removed soil may be formed at the point where the reversing motion of skid-steer 14 is stopped. In order to remove this pile of soil, the operator simply turns the skid-steer 14, manipulates the hydraulic actuators 12 to return the cutting attachment to the orientation shown in FIG. 5 and then using the flat second blade 20, pushes the pile of soil out of the swale 50.

It will be understood that while cutting attachment 10 is shown as mountable on the front end of a landscaping, attachment 10 could, alternatively, be mounted on a rear end of a vehicle which is then moved over the terrain to cut a profile therein.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A cutting attachment for forming gentle depressions in terrain; said
cutting attachment comprising:
a frame adapted to be mounted to a landscaping vehicle and being operationally connected to an actuating system on said vehicle;
a first blade mounted on the frame; said first blade having a fixed, substantially open-V-shape when viewed from above, whereby an apex of said V-shaped first blade is positioned farthest outwardly away from said landscaping vehicle; and
a latch adapted to removably connect the frame to the landscaping vehicle.

2. The cutting attachment as defined in claim 1, wherein said first blade has a substantially truncated V-shape when viewed from above; said
apex of said first blade being truncated.

3. The cutting attachment as defined in claim 2, wherein the first blade comprises a first, a second and a third segment that are immovably connected to each other to form the V-shape.

4. The cutting attachment as defined in claim 3, wherein said first and second segments are disposed at a first angle relative to each other;
and said second and third segments are disposed at a second angle relative to each other; and said first and second angles are fixed.

5. The cutting attachment as defined in claim 4, wherein each of the first and second angles is between 140° and 160°.

6. The cutting attachment as defined in claim 5, wherein both the first and second angles are 150°.

7. The cutting attachment as defined in claim 3, wherein each of the first, second and third segments comprises:
a substantially straight portion; and
an angled portion extending outwardly and rearwardly away from said straight portion; and wherein said angled portion is adapted to engage a surface of the terrain into which a swale is to be cut.

8. The cutting attachment as defined in claim 7, wherein the angled portion of each of the first and third segments of the first blade is disposed at a third angle relative to the straight portion thereof; and the angled portion of the second segment of the first blade is disposed at a fourth angle relative to the straight portion thereof.

9. The cutting attachment as defined in claim 8, wherein the third and fourth angles are each between 1400 and 1600.

10. The cutting attachment as defined in claim 9, wherein the third angle is 150°.

11. The cutting attachment as defined in claim 9, wherein the fourth angle is 145°.

12. The cutting attachment as defined in claim 1, further comprising a second blade; said second blade being pivotally mounted to an outer surface of the first blade.

13. The cutting attachment as defined in claim 12, wherein the first blade comprises a first, a second and a third segment that are immovably connected to each other to form the V-shape of the first blade; and wherein the second blade comprises three separate sections; each one of the three sections being individually pivotally mounted to one of the first, second and third segments of the first blade.

14. The cutting attachment as defined in claim 13, wherein each of the three sections of the second blade comprises:
a first plate having an interior and an exterior surface; said first plate being pivotally mounted to the outer surface of one of the first, second and third segments of the first blade; and
a second plate that is detachably mounted to the exterior surface of the first plate; and wherein the first plate pivots between a first position where the interior surface thereof is in abutting contact with the outer surface of the one of the first, second and third segments of the first blade;
and a second position where the interior surface of the first plate is disposed a distance away from the outer surface of the one of the first, second and third segments.

15. The cutting attachment as defined in claim 1, further comprising:
a pair of spaced-apart side walls extending rearwardly away from the first blade;
a crossbar extending between the side walls.

16. The cutting attachment as defined in claim 15, wherein said latch comprises:
a connector plate mounted on the crossbar, said connector plate being adapted to be connected to the landscaping vehicle.

17. The cutting attachment as defined in claim 15, further comprising:
a shield; said shield being connected to an upper end of the first blade and extending rearwardly toward the crossbar.

18. A method of cutting a swale in terrain with a landscaping vehicle, said method comprising the steps of:
(a) connecting a swale-cutting attachment to an actuating system of the landscaping vehicle; wherein the swale-cutting attachment includes a frame having a rigid, substantially V-shaped first blade fixedly mounted thereon;
(b) positioning the first blade on the terrain to be shaped;
(c) engaging the actuating system to tilt the frame so that a lowermost edge of the first blade bites into the terrain;
and
(d) moving the landscaping vehicle in a first direction across the terrain, whereby the first blade scrapes a quantity of material from the terrain and the terrain assumes the shape of the first blade.

19. The method of cutting a swale as defined in claim 18, further including the step of:
(e) pivoting the landscaping vehicle after step (d) to dispose of material removed from the terrain.

20. The method of cutting a swale as defined in claim 19, further comprising the step of:
(f) engaging the actuating system to alter the tilt of the frame and thereby pivoting a second blade mounted on the first blade from a first position, where an interior surface of the second blade is remote from the first blade, to a second position where the interior surface of the second blade abuts the first blade;
(g) positioning the frame so that a lowermost edge of the second blade engages the terrain;
(h) moving the landscaping vehicle in a second direction across the terrain, whereby the second blade pushes material off an upper surface of the terrain.

21. The method of cutting a swale as defined in claim 19, further comprising the step of:
repeating steps (b) through (h) until a desired swale profile is cut into the terrain.
